(19) United States
(12) Patent Application Publication
(10) Pub. No.: US 2015/0108771 A1
(43) Pub. Date: Apr. 23, 2015

(54) SOLENOID-DRIVEN LATCH AND EJECTOR DEVICE

(71) Applicant: Advantage Pharmacy Services LLC, Madison, MS (US)

(72) Inventors: John Todd Barrett, Madison, MS (US); Fred P. Schoville, Brighton, MI (US)

(21) Appl. No.: 14/520,960

(22) Filed: Oct. 22, 2014

Related U.S. Application Data
(60) Provisional application No. 61/894,463, filed on Oct. 23, 2013.

(51) Int. Cl. E05C 3/22; E05C 3/12

(52) U.S. Cl. CPC E05C 3/22; E05C 3/12
USPC 292/229; 292/201

(57) ABSTRACT

A solenoid-driven latch and ejector device to latch and selectively unlatch and eject an object. An electromechanical solenoid produces linear motion, and a latch and ejector arm is operatively coupled to the solenoid for pivotal movement about a pivot axis of the arm.

### TECHNICAL FIELD

The field to which the disclosure generally relates includes electromechanical latches.

### BACKGROUND

Electromechanical latches have many uses, for example, to latch drawers to cabinets. Conventional latches typically include complex mechanical parts and kinematics, and costly electrical devices and configurations. Also, although conventional latches may be used to latch and unlatch objects, they are not used to eject the objects.

### BRIEF SUMMARY

The present disclosure is directed to a solenoid-driven latch and ejector to latch and selectively unlatch and eject an object.

### BRIEF DESCRIPTION OF THE DRAWINGS

Illustrative embodiments of the invention will become more fully understood from the detailed description and the accompanying drawings, wherein:

FIG. 1 is a side view of an apparatus including a solenoid-driven latch and ejector device according to one illustrative embodiment;

FIG. 2 is a top view of the apparatus of FIG. 1;

FIG. 3 is a bottom view of the apparatus of FIG. 1;

FIG. 4 is a upper rear perspective view a solenoid-driven latch and ejector device according to another illustrative embodiment;

FIG. 5 is a side view of the device of FIG. 4;

FIG. 6 is an opposite side view of the device of FIG. 4;

FIG. 7 is a top view of the device of FIG. 4;

FIG. 8 is a bottom view of the device of FIG. 4;

FIG. 9 is a rear view of the device of FIG. 4;

FIG. 10 is a front view of the device of FIG. 4;

FIG. 11 is a side view of a solenoid-driven latch and ejector device according to a further illustrative embodiment;

FIG. 12 is a side view of a solenoid-driven latch and ejector device according to an additional illustrative embodiment;

FIG. 13 is a side view of a solenoid-driven latch and ejector device according to yet another illustrative embodiment; and

FIG. 14 is a side view of the device of FIG. 13 in an extended position.

### DETAILED DESCRIPTION OF ILLUSTRATIVE EMBODIMENTS

The following description of the embodiment(s) is merely illustrative in nature and is in no way intended to limit the invention, its application, or uses.

The content of U.S. Patent Application Publication 2013/0018505 is assigned to the assignee hereof and is hereby incorporated herein by reference in its entirety. The present disclosure includes any combination of any of the embodiments herein with any of the embodiments of the aforementioned 2013/0018505 publication.

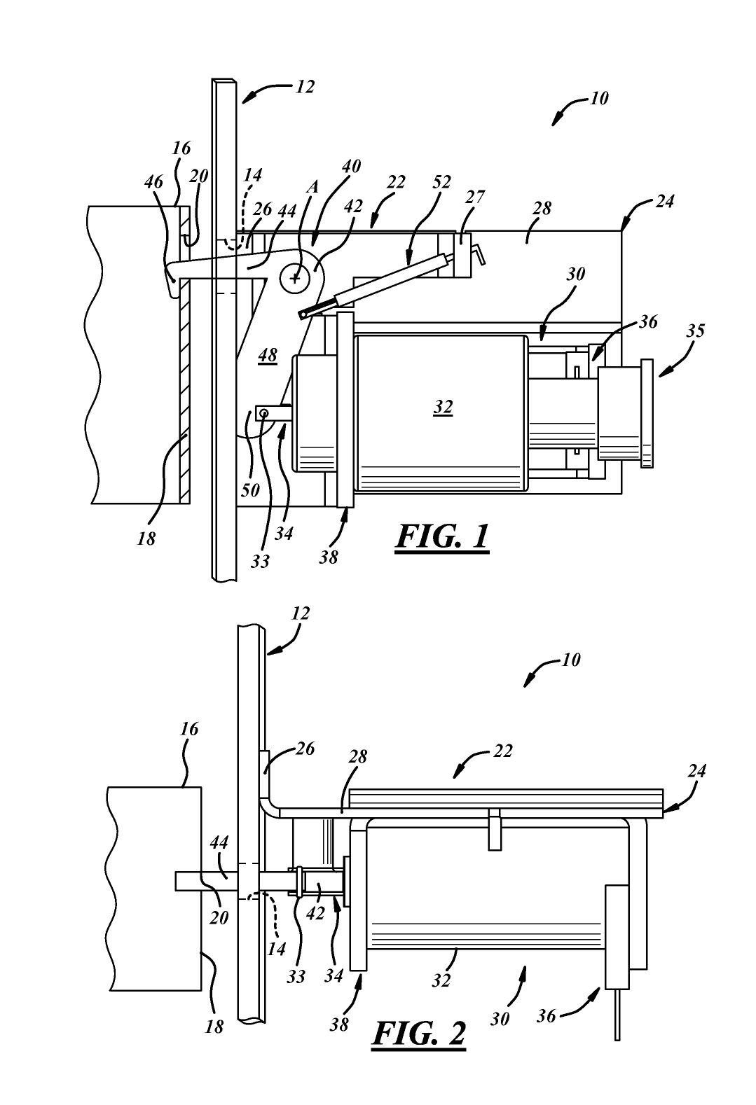

FIG. 1 illustrates an apparatus 10 that may include a medicine cabinet or cart or the like. The apparatus 10 may include a backplane 12 having a backplane aperture 14 therethrough, and a drawer 16 disposed on one side of the backplane and including a rear wall 18 having a drawer aperture 20 therethrough. The apparatus 10 also includes a solenoid-driven latch and ejector device 22 disposed on another side of the backplane 12 to latch the drawer 16 to the backplane 12 and selectively unlatch the drawer 16 and eject the drawer 16 away from the backplane 12.

The device 22 may include a mounting bracket 24 that may have a backplane flange 26 that may be mounted to a rear surface of the backplane 12 and a device flange 28 extending from the backplane flange 26 for supporting other portions of the apparatus as described below. The flanges 26, 28 may be one piece, as illustrated, or may be of multiple pieces. The bracket 24 also may have a tab 27, as described below.

The device 22 also includes an electromechanical solenoid 30 that produces linear motion and includes a housing 32, and a plunger 34 carried by the housing 32 and that moves linearly with respect thereto. The solenoid 30 also may include a rear plunger extension 35 for manual activation of the device 22, for example, to manually unlatch and eject the drawer 16. The solenoid 30 further may include an electrical connector 36 of any suitable type for receiving power and control signals. Also, the solenoid housing 32 may be coupled directly to the device flange 28 of the mounting bracket 24 in any suitable manner, or may be coupled via a solenoid bracket 38, which, in turn, may be coupled to the mounting bracket 24 in any suitable manner. The solenoid 30 may include a low power, high pull, long stroke, closed frame solenoid available from ByTec Inc., of Clinton Township, Mich.

The device 22 also includes a latch and ejector arm 40 coupled to the solenoid 30 for pivotal movement about a pivot axis A of the arm 40. The arm 40 may be unitary and includes a hub 42 through which the pivot axis A extends. The hub 42 may be pivotably coupled to the mounting bracket 24 via a pivot element 43. The pivot element 43 may be an integral portion of the hub 42 that is pivotably carried by the bracket 24 in any suitable manner, or a separate component pivotably coupled between the bracket 24 and the hub 42 in any suitable manner. The arm 40 further includes a latch 44 extending in a direction away from the hub 42 and having a bayonet end 46 to latch an object, for example, the drawer 16. The latch 44 may extend radially straight away from the hub 42. The bayonet end 46 may be of any suitable geometry that allows the drawer or other object to engage the end 46 and raise the latch 44, and that allows the end 46 to catch behind a portion of the drawer or other object when the latch 44 lowers. As illustrated, the bayonet end 46 includes a barb-like geometry, but any other suitable geometry for latching to the other object may be used.

The arm 40 also includes an ejector 48 extending in another direction away from the hub 42 and having an ejection end 50 to eject the object. The ejector 48 may extend radially straight away from the hub 42 and at an acute angle with respect to the latch 44, for example, wherein the arm is shaped like the numeral “7” when viewed from the side. In any case, the solenoid plunger 34 may be coupled to the ejection end 50 of the ejector 48 (at a location along the length of the ejector 48 more than halfway between the axis A and the extreme end of the ejector 48) to pivot the arm 40 about the axis A. More specifically, the plunger 34 may be coupled to the ejector 48 at a location along the last 20% of its length, distal with respect to the pivot axis A. The plunger 34 may be pivotably coupled to the ejector 48 via a pin 33 that may extend through the end of the plunger 34 and the end 50 of the ejector 48 for pushing and pulling on the ejector 48.

The device further may include a spring 52 to bias the arm 40 toward the solenoid 30 to a home or latched position, as illustrated wherein the ejector 48 has moved toward the solenoid 30. The spring 52 may directly bias the arm 40 and may be a tension spring having one end coupled to the ejector 48 and another end coupled to the device flange 28 of the mounting bracket 24, either directly via the bracket tab 27 or any other suitable portion of the bracket 24 or via a pin or any other suitable intermediate element(s). Although not separately shown, the solenoid 30 itself may include a return spring instead or in addition to the spring 52 to indirectly bias the arm 40 to its latched position. Such a solenoid spring may be internal to the solenoid housing or may be external with respect thereto, for example, between a rear end of the solenoid housing and a rear end of the solenoid plunger. In any event, any suitable portion of the apparatus 10 may provide protection for an exposed rear end of the solenoid plungers, for example, a rear cover of the cabinet or cart, or the like.

In operation, the solenoid 30 is activated to displace the plunger 34 toward the arm 40 to thereby pivot the arm 40 about the axis A from its home or latched position. Consequently, the drawer 16 is unlatched by raising of the latch 44 and the drawer 16 is ejected away from the backplane 12 by outward displacement of the ejector 48 against the rear of the drawer 16. Thereafter, the solenoid 30 is deactivated and the arm pivots back to its home position. A user may reinsert the drawer 16 toward the backplane 12 so that the drawer 16 engages the latch 48 to raise the latch 48 until it drops into latched engagement behind a corresponding portion of the drawer 16 to lock the drawer 16 with respect to the backplane 12 and other portions of the apparatus 10.

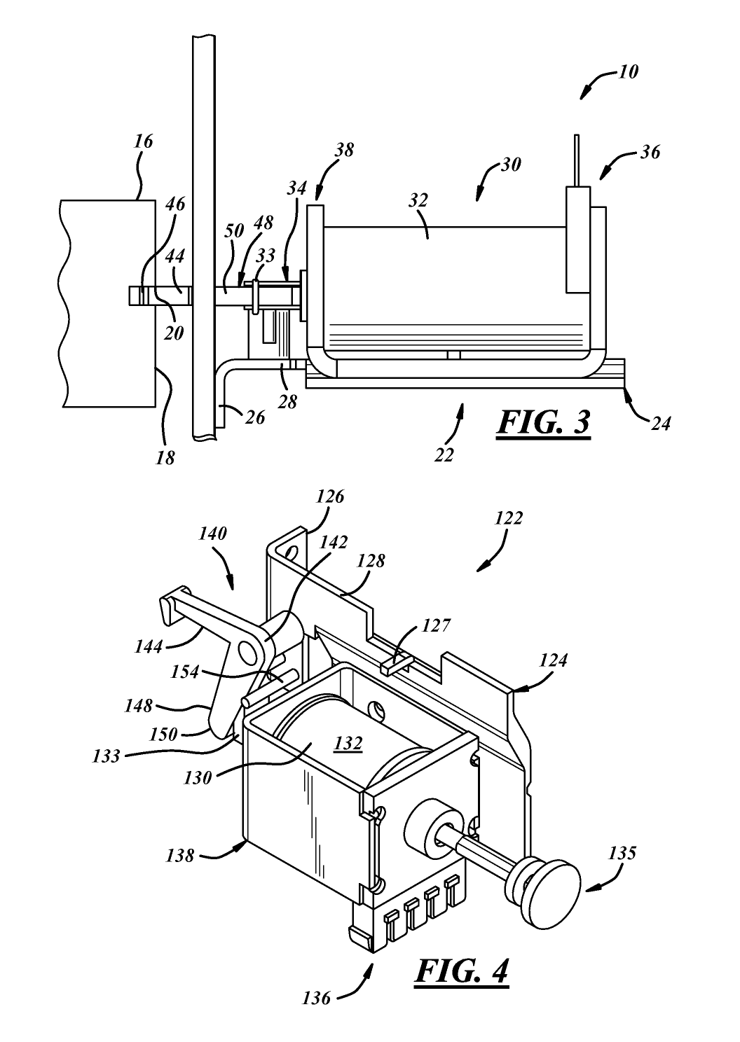

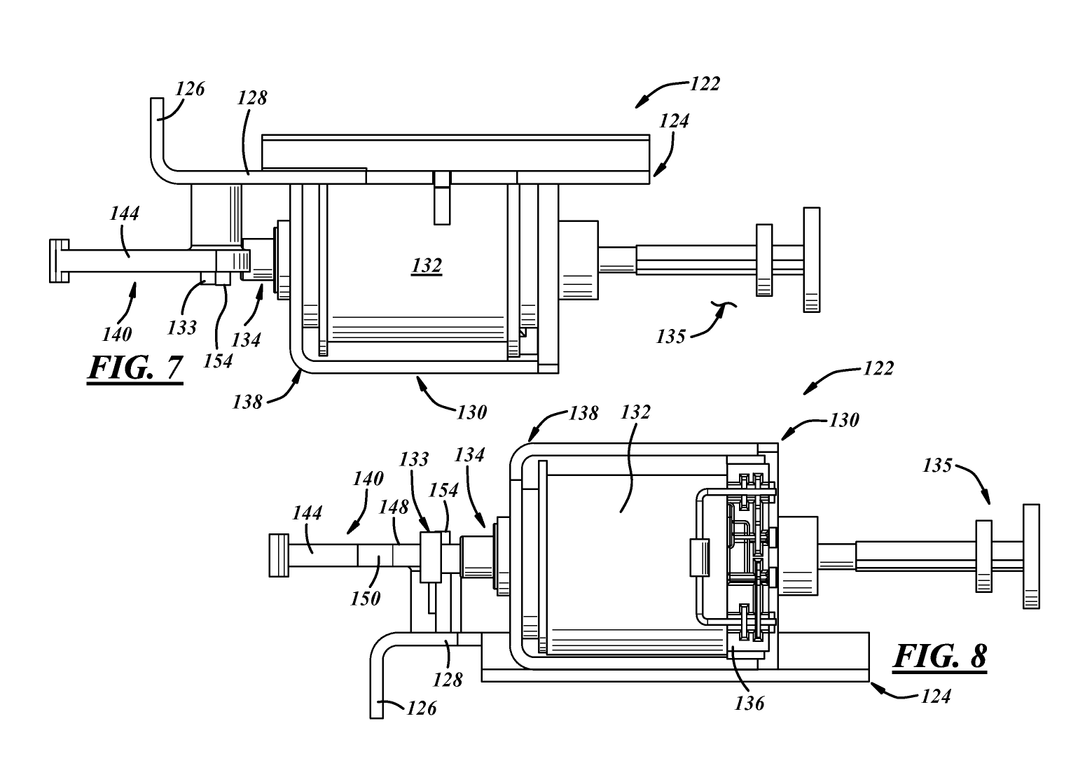

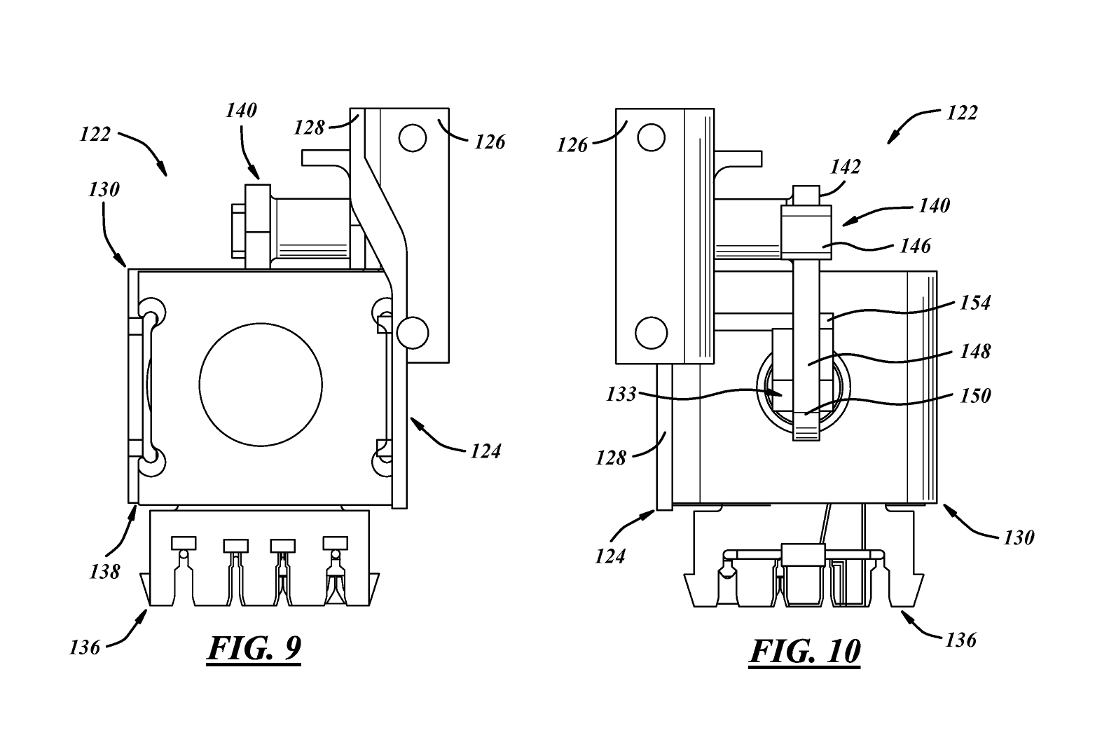

FIGS. 4-10 illustrate another illustrative embodiment of a solenoid-driven latch and ejector device 122. This embodiment is similar in many respects to the embodiment of FIGS. 1-3 and like numerals between the embodiments generally designate like or corresponding elements throughout the several views of the drawing figures. Accordingly, the descriptions of the embodiments are hereby incorporated into one another, and description of subject matter common to the embodiments generally may not be repeated.

The device 122 includes a mounting bracket 124 having a backplane flange 126, device flange 124, and spring tab 127. Also, the device includes a solenoid 130 that may include a housing 132, a plunger 134, a rear plunger extension 135, and an electrical connector 136. The solenoid housing 132 may be coupled indirectly to the device flange 128 of the mounting bracket 124 via a solenoid bracket 138 coupled to the solenoid 130 and may be coupled to the mounting bracket 124 in any suitable manner.

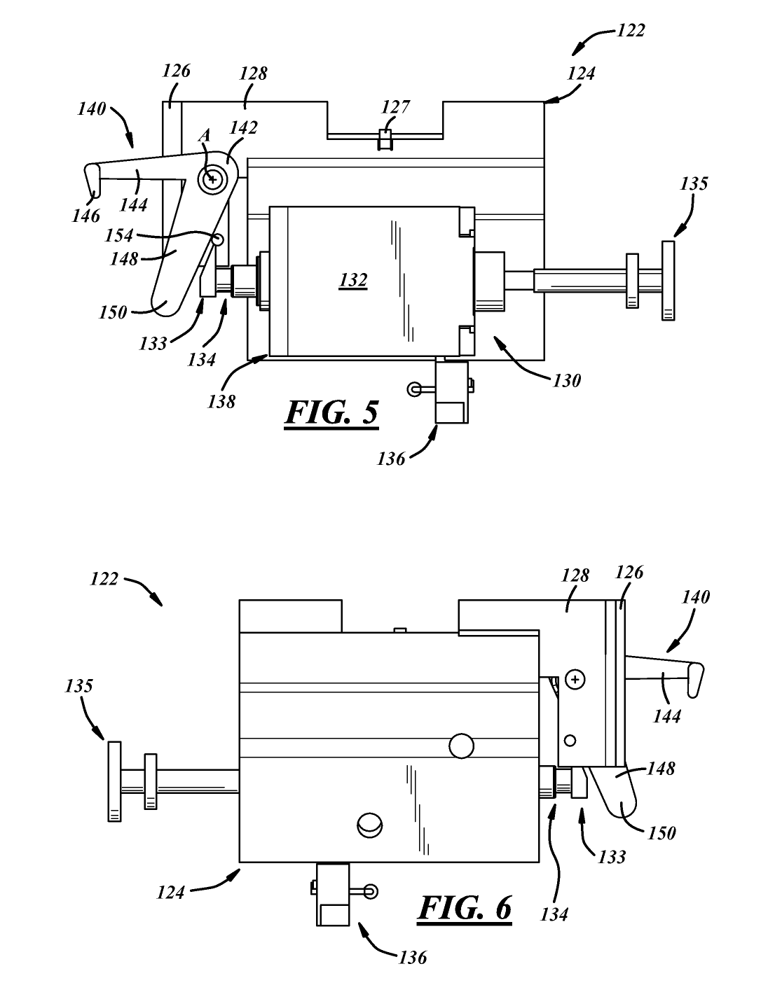

The device 122 also includes a latch and ejector arm 140 that may be unitary and that is coupled to the solenoid 130 and including a hub 142, a latch 144, and an ejector 148. The solenoid plunger 134 (FIG. 5) may cooperate with the ejector 148 via a shoe 133 coupled to the end of the plunger 134 in any suitable manner and that may be disposed adjacent to and against the end 150 of the ejector 148 for pushing the ejector 148. As shown, the shoe 133 may include an angled surface complementary to a corresponding rear surface of the ejector 148. Also, the device 122 may include an arm stop 154 to provide a positive stop to prevent the arm 140 from damaging the solenoid 130. The stop 154 may be a post or other separate component coupled in any suitable manner to the device flange 128 of the bracket 124 or may be an integral tab thereof. The stop 154 may be located between the arm 140 and the solenoid 130 and, more particularly, between the ejector 148 and the solenoid 130.

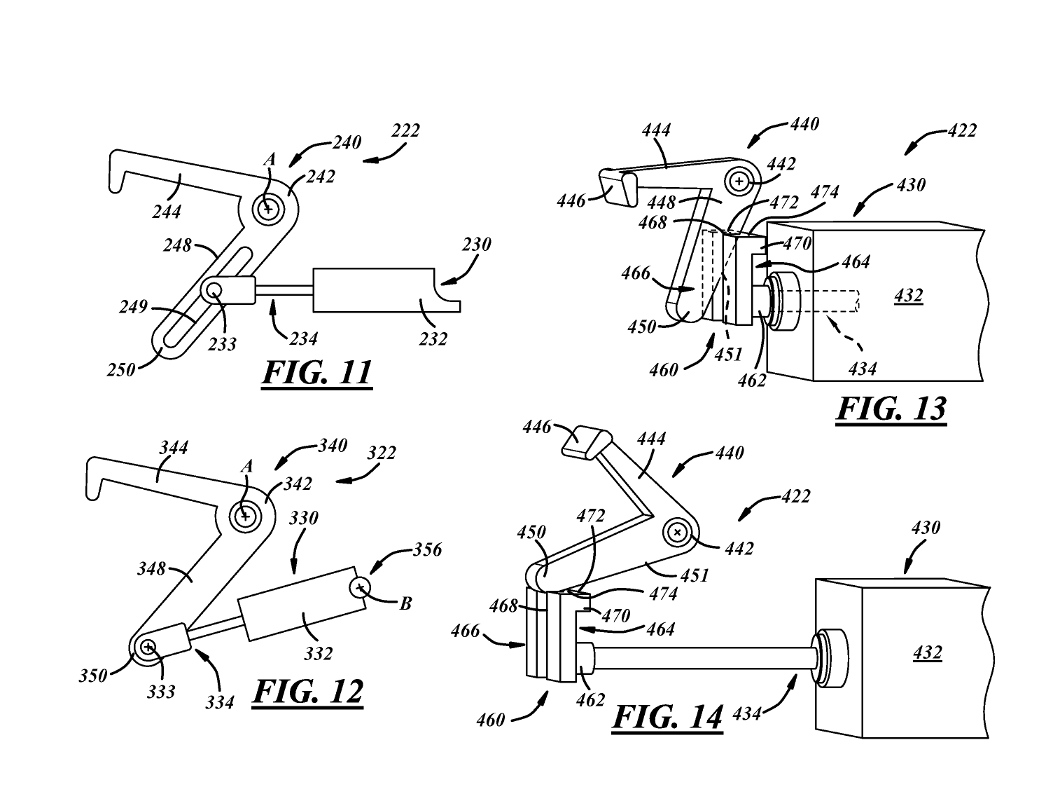

FIGS. 11 and 12 illustrate other illustrative embodiments of solenoid-driven latch and ejector devices 222, 322. These embodiments are similar in many respects to the embodiment of FIGS. 1-10 and like numerals between the embodiments generally designate like or corresponding elements throughout the several views of the drawing figures. Accordingly, the descriptions of the embodiments are hereby incorporated into one another, and description of subject matter common to the embodiments generally may not be repeated.

With reference to FIG. 11, the device 222 includes a solenoid 230 having a housing 232, and a plunger 234 wherein the housing 232 may be coupled to a mounting bracket (not shown) in any suitable manner, for example, as discussed above. The device 222 also includes a latch and ejector arm 240 that may be unitary and is coupled to the solenoid 230 and including a hub 242, a latch 244, and an ejector 248. The solenoid plunger 234 cooperates with the ejector 248 via a pin-and-slot arrangement. More specifically, the ejector 248 includes a slot 249 therein and extending therealong in which a pin 233 is carried and coupled to the end of the plunger 234 in any suitable manner, for pushing and pulling the ejector 248 so that the arm 240 pivots about the axis A. The slot 249 may extend from the end 250 toward the hub 242 and may extend over halfway along the length of the ejector 248.

With reference to FIG. 12, the device 322 includes a solenoid 330 having a housing 332, and a plunger 334 wherein the solenoid 330 is pivotably coupled to the mounting bracket (not shown) via a pivotable connection 356. The connection 356 may include a pin, shaft, or the like that may extend through a portion of the housing 332 and/or the solenoid bracket (not shown) and through a portion of the device flange of the mounting bracket. The device 322 also includes a latch and ejector arm 340 that may be unitary and is coupled to the solenoid 330 and including a hub 342, a latch 344, and an ejector 348. The solenoid plunger 334 may be pivotably coupled to the ejector 348, for example, as described above with respect to FIG. 1. Accordingly, the solenoid 330 may pivot over an arc as the arm 340 pivots during latching and unlatching movement of the arm 340.

FIGS. 13 and 14 illustrate another illustrative embodiment of a solenoid-driven latch and ejector device 422. This embodiment is similar in many respects to the embodiment of FIGS. 1-12 and like numerals between the embodiments generally designate like or corresponding elements throughout the several views of the drawing figures. Accordingly, the descriptions of the embodiments are hereby incorporated into one another, and description of subject matter common to the embodiments generally may not be repeated.

With reference to FIG. 13, the device 422 includes a solenoid 430 having a housing 432, and a plunger 434 wherein the housing 432 may be pivotably or non-pivotably coupled to a mounting bracket (not shown) in any suitable manner, for example, as discussed above. The device 422 also includes a latch and ejector arm 440 that may be unitary and is coupled to the solenoid 430 and including a hub 442, a latch 444 with a bayonet end 446, and an ejector 448. The solenoid plunger 434 cooperates with the ejector 448 via a shoe 460 that may be part of and/or coupled to an end of the plunger 434. More specifically, the shoe 460 may include a coupling 462 extending from a rear 464 of the shoe 460 and coupled to the end of a plunger rod of the solenoid 430 in any suitable manner. The shoe 460 also may include a front 466 having a space or slot 468 between sides 470, 472 of the shoe 460 to accept a rear portion 451 of the ejector 448. The shoe 460 provides a suitable interface for at least pushing the ejector 448 so that the arm 440 pivots about the axis A. As illustrated in FIG. 14, the solenoid 430 may be activated to advance the plunger 434 and rotate the ejector 448 about the axis A, for example, until the rear portion 451 of the ejector 448 rests on a top 474 of the shoe 460. Thereafter, the solenoid 430 may be deactivated to retract the plunger 434 and allow the ejector 448 to rotate in the opposite direction about the axis A under the force of gravity, or under a spring force, or the like.

As used in the sections above and claims below, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components, elements, or items. Similarly, when introducing elements of the invention or the example embodiments thereof, the articles “a,” “an,” “the,” and “said” are intended to mean that there are one or more of the elements. Moreover, directional words such as front, rear, top, bottom, upper, lower, radial, circumferential, axial, lateral, longitudinal, vertical, horizontal, transverse, and/or the like are employed by way of description and not limitation. Other terms are to be construed using their broadest reasonable meaning unless they are used in a context that requires a different interpretation.

Finally, the foregoing description is not a definition of the invention, but is a description of one or more examples of exemplary embodiments of the invention. The statements contained in the foregoing description relate to the particular examples and are not to be construed as limitations on the scope of the invention as claimed below or on the definition of terminology used in the claims, except where terminology is expressly defined above. And although the present invention has been disclosed using a limited number of examples, many other examples are possible and it is not intended herein to mention all of the possible manifestations of the invention. In fact, other modifications, variations, forms, ramifications, substitutions, and/or equivalents will become apparent to those skilled in the art in view of the foregoing description. The present invention is intended to embrace such forms, ramifications, modifications, variations, substitutions, and/or equivalents as fall within the spirit and broad scope of the following claims. In other words, the present invention encompasses many substitutions or equivalents of limitations recited in the following claims. For example, the materials, sizes, and shapes, described above could be readily modified or substituted with other similar materials, sizes, shapes, and/or the like. Therefore, the invention is not limited to the particular examples of exemplary embodiments disclosed herein, but instead is defined solely by the claims below.

What is claimed is:

1. A solenoid-driven latch and ejector device to latch and selectively unlatch and eject an object, comprising:
an electromechanical solenoid to produce linear motion and including a housing and a plunger carried by the housing and that moves linearly with respect thereto;
a latch and ejector arm operatively coupled to the solenoid for pivotal movement about a pivot axis of the arm and including:
a hub through which the pivot axis extends,
a latch extending in a direction away from the hub and having a bayonet end to latch an object,
an ejector extending in another direction away from the hub and having an ejection end to eject the object; and
a spring to bias the arm toward a home position.

2. The device of claim 1, wherein the ejector extends at an acute angle with respect to the latch.

3. The device of claim 1, wherein the arm is shaped like the numeral 7.

4. The device of claim 1, wherein the plunger is pivotably coupled to the ejection end of the ejector to push and pull the ejector and pivot the arm about the axis.

5. The device of claim 1, wherein the spring is a tension spring having one end coupled to the ejector.

6. The device of claim 1, further comprising a mounting bracket having a backplane flange for mounting to a backplane and a device flange extending from the backplane flange for supporting the solenoid and arm, wherein the solenoid and the arm are carried on the same side of the flange.

7. The device of claim 6, the spring is a tension spring having one end coupled to the ejector and another end coupled to the mounting bracket.

8. The device of claim 1, further comprising an arm stop located between the arm and the solenoid.

9. The device of claim 1, wherein the plunger includes a shoe that engages the ejector to push on the ejector.

10. The device of claim 1, wherein the solenoid plunger cooperates with the ejector via a pin-and-slot arrangement.

11. The device of claim 11, wherein the ejector includes a slot therein and extending therealong in which a pin is carried and coupled to the end of the plunger for pushing and pulling the ejector.

12. The device of claim 1, further comprising a mounting bracket having a backplane flange and a device flange extending from the backplane flange for supporting the solenoid and arm, wherein the solenoid and the arm are carried on the same side of the flange, and the solenoid is pivotably coupled to the mounting bracket via a pivotable connection.

13. The device of claim 12, wherein the solenoid plunger is pivotably coupled to the ejector.

14. The device of claim 1, wherein the plunger includes a shoe that engages the ejector to push on the ejector, and the shoe includes a front with a slot between sides of the shoe to accept a rear portion of the ejector.

15. An apparatus, comprising:
a backplane having a backplane aperture therethrough;
a drawer disposed on one side of the backplane and including a rear wall having a drawer aperture; and
a solenoid-driven latch and ejector device disposed on another side of the backplane to latch the drawer to the backplane and selectively unlatch the drawer and eject the drawer away from the backplane, and including:
an electromechanical solenoid to produce linear motion and including a housing, and a plunger carried by the housing and that moves linearly with respect thereto;
a latch and ejector arm coupled to the solenoid for pivotal movement about a pivot axis of the arm and including:
a hub through which the pivot axis extends,
a latch extending in a direction away from the hub and having a bayonet end to latch an object,
an ejector extending in another direction away from the hub and having an ejection end to eject the object; and
a spring to bias the arm toward a home position.

16. The apparatus of claim 15, wherein the device is coupled to a rear surface of the backplane.

17. The apparatus of claim 15, further comprising a mounting bracket having a backplane flange for mounting to the backplane and a device flange extending from the backplane flange for supporting the solenoid and arm, wherein the solenoid and the arm are carried on the same side of the flange.

18. The apparatus of claim 15, wherein the spring is a tension spring having one end coupled to the ejector and another end coupled to the mounting bracket.
